(19) United States
(12) Patent Application Publication
(10) Pub. No.: US 2008/0179969 A1
(43) Pub. Date: Jul. 31, 2008

(54) ASSEMBLY FOR TRANSMITTING N-PHASE CURRENT

(76) Inventors: Kevin A. Dooley, Mississauga (CA); Joshua David Bell, Toronto (CA); Gilles D. Gagnon, Gerogetown (CA); Michael J. Dowhan, Milton (CA); Joseph Brand, Mississauga (CA); Jerzy Wasiewicz, Brampton (CA)

Correspondence Address: OGILVY RENAULT LLP (PWC), 1981 MCGILL COLLEGE AVENUE, SUITE 1600, MONTREAL, QC, H3A 2Y3, omitted

(21) Appl. No.: 11/669,597

(22) Filed: Jan. 31, 2007

(51) Int. Cl. H01B 7/30

(52) U.S. Cl. 307/147

(57) ABSTRACT

An assembly and method for providing at multiphase current signals in which a plurality of conductors is arranged with conductors carrying dissimilar phases adjacent one another, and preferably in a balanced arrangement, such that the induced magnetic fields are subtractive from each other, and the assembly with reduced inductance results.

### TECHNICAL FIELD

This application relates to transmitting an N-phase current signal.

### BACKGROUND

Transmitting an N-phase current signal over a transmission line may lead to the generation of an inductance, as each conductor connected to a phase of the current signal generates a corresponding magnetic field. To reduce the negative effects associated with such inductance, such as electromagnetic radiation and inductive reactance which can especially be a problem in high frequency power systems, requires a proper balancing of the transmission line. The balancing may be achieved using a capacitance, however, the value of such inductance must properly be estimated in order to achieve a proper balancing, and the solution is not applicable to variable frequency systems. Improvement is desired.

### SUMMARY

According to one aspect, there is provided a current feeder assembly for feeding a 3-phase current signal from a source to a destination. The assembly comprises a plurality of insulated conductors configured to feed the 3-phase current signal, each conductor having a rectangular cross-section defined by four sides, the plurality of conductors provided in a rectangular array with the sides of adjacent conductors adjacent one another, the conductors arranged within the array such that the sides of a given conductor of the array feeding a given current phase are adjacent only conductors feeding the other two current phases.

According to an aspect, there is provided a feeder assembly for feeding a multiphase current signal from a source to a destination. The assembly comprises a plurality of insulated conductors, each conductor having a perimeter and being configured for carrying one phase of the multiphase current signal, each given conductor of the plurality being bordered about the perimeter substantially by conductors of the plurality feeding phases dissimilar to a phase fed by the given conductor.

According to an aspect, there is provided a method of feeding a multiphase current signal. The method comprises the steps of: providing a plurality of conductors configured to feed the multiphase current signal; and arranging the conductors relative to one another so that a magnetic field induced by current of a given phase passing through the conductors is substantially cancelled by magnetic fields induced by currents of dissimilar phases passing simultaneously through adjacent conductors.

### BRIEF DESCRIPTION OF THE DRAWINGS

Further features and advantages will become apparent from the following detailed description, taken in combination with the appended drawings, in which:

FIG. 1 is a schematic diagram showing an embodiment of an assembly comprising an input connector, a transmission assembly and an output connector;

FIG. 2 is a isometric view of an embodiment of the assembly of FIG. 1 configured for providing a 3-phase current signal;

FIG. 2a is an enlarged view of a lower portion of FIG. 2;

FIG. 2b shows an exploded isometric view of a conductor of the assembly of FIG. 2;

FIG. 3 is a side view of the assembly of FIG. 2;

FIG. 3a is an enlarged view of a lower portion of FIG. 3;

FIG. 4 is a lateral cross-section through the device of FIG. 2;

FIG. 4a is an enlarged view of a portion of FIG. 4; and

FIGS. 5a, 5b and 5c are views, similar to the lateral cross-section of FIG. 4, of few further examples of the many possible embodiments available to the designer.

It will be noted that throughout the appended drawings, like features are identified by like reference numerals.

### DETAILED DESCRIPTION

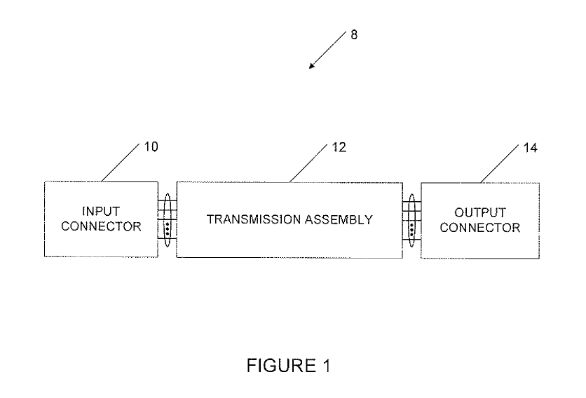

Now referring to FIG. 1, there is shown an embodiment of an assembly 8 for providing an N-phase current signal.

The assembly 8 comprises an input connector 10, a transmission assembly 12 and an output connector 14.

The input connector 10 is used for receiving each signal of an N-phase current signal provided by an N-phase current signal source. In one embodiment, the N-phase current signal source comprises a 3-phase generator. In another embodiment, the 3-phase current signal source comprises a motor drive system.

The input connector 10 provides each signal of the N-phase current signal to the transmission assembly 12. The output connector 14 is used for providing the corresponding N-phase current signal to an N-phase current signal destination.

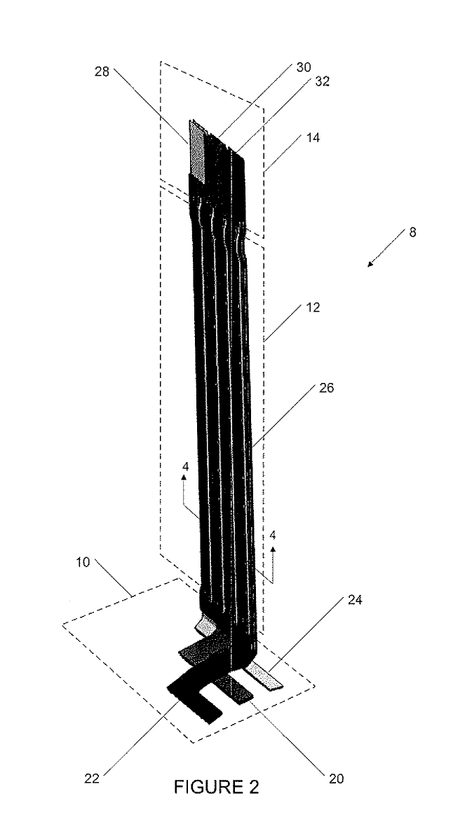

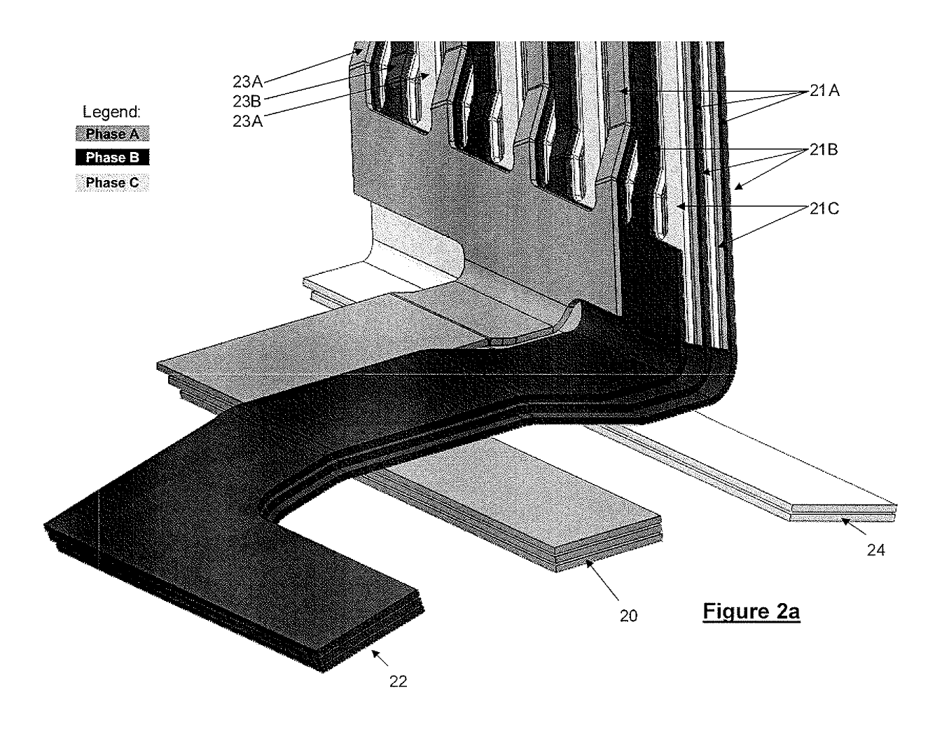

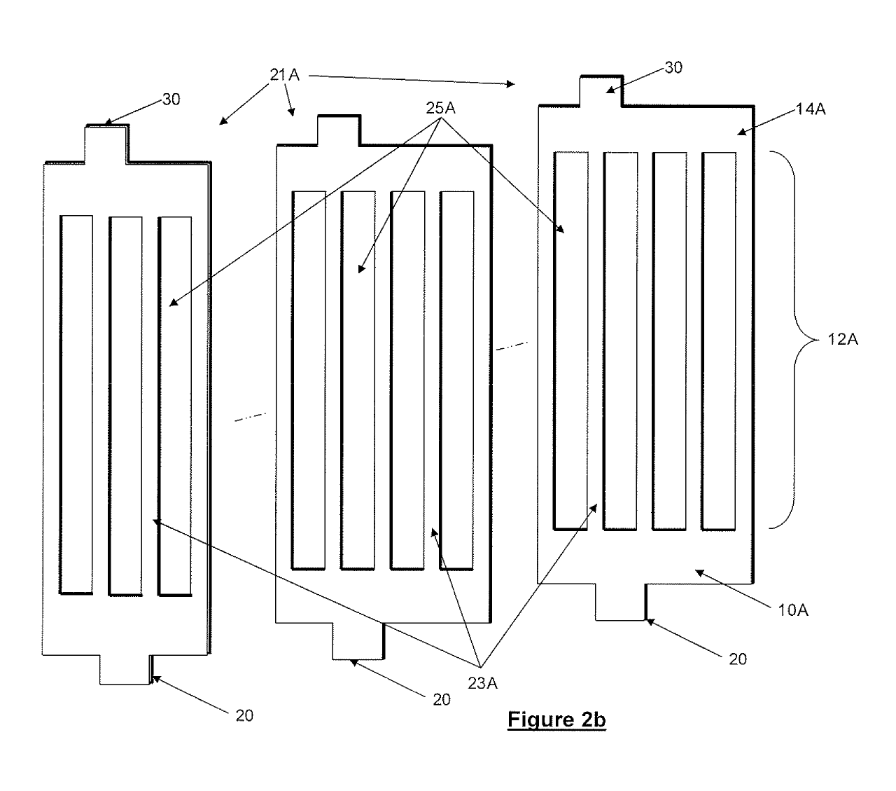

The transmission assembly 12 comprises a plurality of conductors 26, each for receiving one of the N-phase current signals from the input connector 10 and for transmitting the N-phase current signal to the output connector 14. The plurality of conductors 26 are insulated from one another, as are the different phases of the input and output connectors 10, 14. In one embodiment depicted in FIGS. 2-4a, and described further below, the plurality of conductors 26 forms a flat conductor group constructed from several layers of insulated printed flexible circuit for carrying high current, high frequency three-phase power.

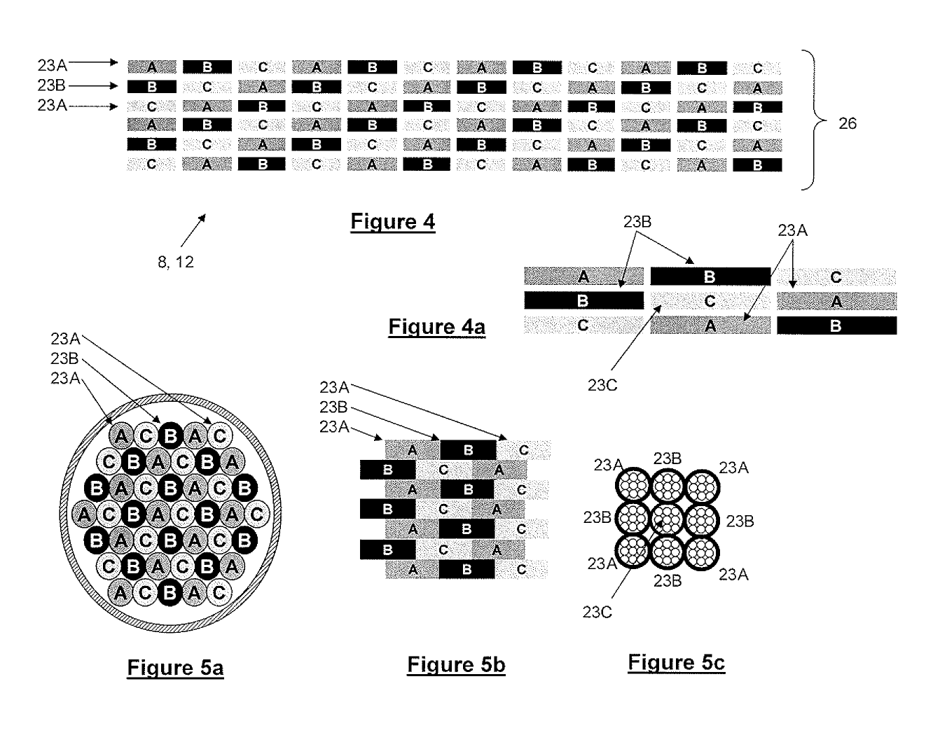

As explained further below with reference to FIG. 4, the plurality of conductors 26 are provided in a layered pattern of individual conductor legs 23, wherein any given conductor leg 23 of a given phase, say phase A, at a given location has, as its nearest neighbouring conductors (i.e. adjacent to or bordering on the perimeter of the conductor), conductor legs 23 from the other phases, say phase B and phase C, so as to provide a “sandwich” in which the sides of the conductor leg 23 of the given phase is surrounded by conductors other phases. Doing so results in the magnetic field generated by the current flowing in a given conductor being substantially reduced/cancelled by magnetic fields generated by the current flowing in neighbouring conductors.

Magnetic fields can be represented by vectors. The magnitude of the magnetic field vectors will change with the phase of the current signals flowing in the conductors. The magnetic field vectors in the vicinity of the conductors in a layered pattern, such as according to the embodiments described herein, will tend to cancel each other out leaving a total magnetic field vector for the transmission assembly having a low value. The low value is one that is reduced compared to the total magnetic field value where there is no organized layout pattern such as those described herein. In fact, the low value of the total magnetic field results in a reduced value of the effective series inductance of the conductors.

The objective is to substantially reduce or eliminate the inductance associated with a balanced 3-phase feeder connected between a generator/motor and a 3-phase load, power control or commutation unit. In the embodiment of FIGS. 2-4, flat insulated rectangular conductors are layered such that each phase feeder line (i.e., each conductor feeding a phase) is sandwiched at least once on each side by the phase feeders of the other two phase feeder lines. In practice this pattern is repeated in this embodiment a number of times, as will be described further below, to form a flat conductor group providing a balanced 3-phase transmission line. This results in the reduction of the effective series inductance of the conductors compared to what would be present with a conventional single group of twisted or braided conductors.

Exemplary layouts of the conductors within the transmission assembly 12 will be further discussed below.

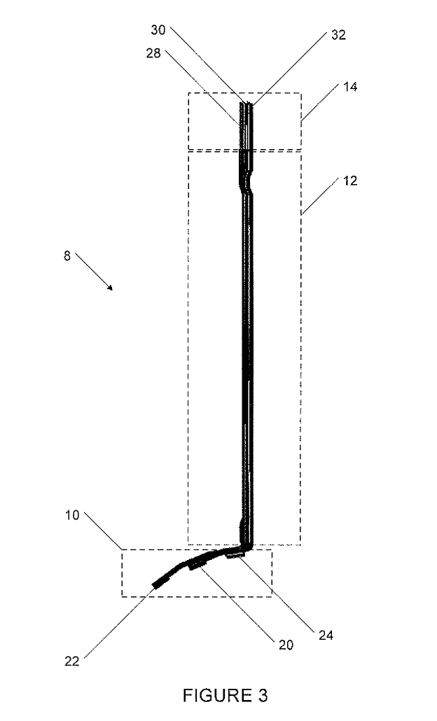

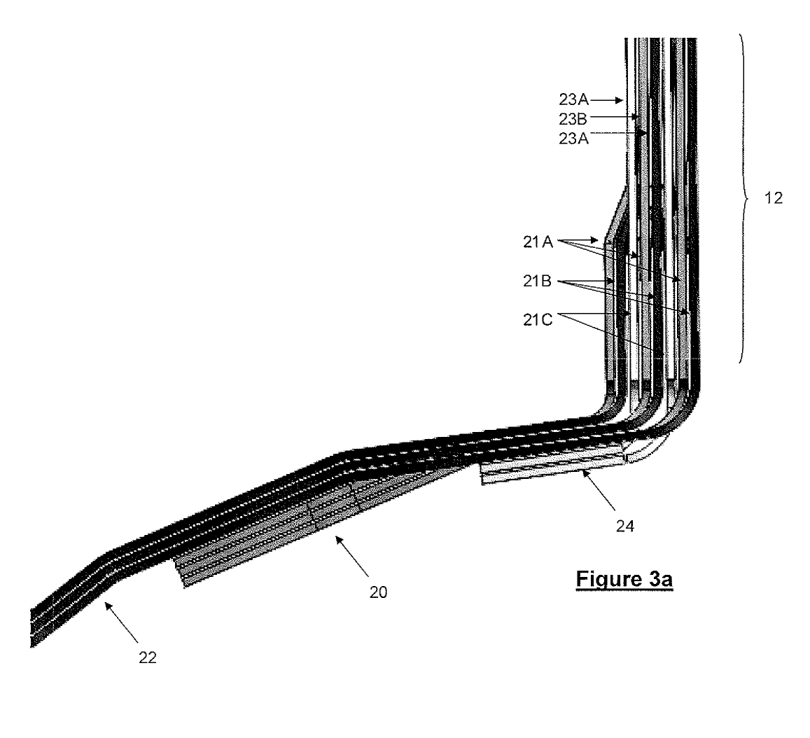

Now referring to FIGS. 2 to 3a, the assembly 8 in one embodiment comprises input connector 10, transmission assembly 12 and output connector 14. The input connector 10 comprises a first phase input conductor 20, a second phase input conductor 22 and a third phase input conductor 24. The output connector 14 comprises a corresponding first phase output conductor 30, a corresponding second phase output conductor 32 and a corresponding third phase output conductor 28.

As seen in FIG. 2b, in this embodiment the first phase conductor 20 (for carrying, say, phase A) comprises (in this case) three conductor layers 21A (represented schematically as rectangular in shape), with each conductor layer having a transmission portion 12A comprising a plurality of legs 23A provided by slots or gaps 25A extending between an input connector portion 10A (providing first phase input conductor 20) and an output connector portion 14A (providing first phase output conductor 30). The legs 23 of the layers 21 are not joined to one another, to facilitate interlacing with the legs 23 of the layers 21 of the other phases, as will be described below. However, the layers 21 may or may not be joined to one another at the input and output portions 10A and 14A, if desired. Each layer 21A is preferably about 0.020-0.030″ thick, with each leg 23A about 0.1″ wide and each slot 25A about 0.005″ wide. The second and third phase conductors 22, 24 (not depicted in FIG. 2b, but for carrying, say, phases B and C, respectively) are similarly constructed of multiple layers 21B, 21C, having slots 25B, 25C defining a plurality of conductor legs 23B, 23C. The number of layers, number and configuration of legs and slots, etc. is to the designer's preference, and need not be as described here.

Referring again to FIGS. 2 to 3a, the first phase input conductor 20 is electrically connected to the corresponding first phase output conductor 32 via a first plurality of conductors (i.e. legs 23A of the respective layers 21A) located in the transmission assembly 12A. Similarly, the second phase input conductor 22 is electrically connected to the corresponding second phase output conductor 30 via a second plurality of conductor legs located in the transmission assembly 12B, and the third phase input conductor 24 is electrically connected to the corresponding third phase output conductor 28 via a third plurality of conductor legs located in the transmission assembly 12C. As can be seen from FIGS. 2a and 3a, in this embodiment the legs 23 of some layers 21 are bent in order to bring the legs into alignment with the desired grid pattern of conductors in the transmission assembly 12.

Referring to FIG. 4, there is shown a cross-section view of the transmission assembly 12 along the lines 4-4 in FIG. 2. As the skilled addressee will appreciate, individual legs 23A, 23B, 23C of the layers 21A, 21B, 21C of the first, second and third phase conductors, respectively, are interlaced and stacked relative to one another to provide an arrangement like that shown in FIG. 4. In this embodiment, the rectangular array of conductor legs 23 is a 12-by-6 grid. Comparing FIG. 4 to FIGS. 2a and 3a, it will be understood that in this embodiment the 12-by-6 grid is provided by the legs 23A, 23B, 23C provided by: three layers 21A carrying phase A; three layers 21B carrying phase B; and two layers 21C carrying phase C.

It can be seen from FIG. 4 that any given conductor leg 23 has as its nearest adjacent neighbours (i.e. those conductors laterally, or immediately, adjacent the four sides of the conductor legs, or those up, down, to the left and to right of the conductor, in FIGS. 4 and 4a) other conductors electrically connected to the other phases. While some conductors diagonally positioned relative to a given conductor may be of the same phase of the given conductor, its inferior position relative to those conductors immediately adjacent the given conductor tends to minimize any additive effect the diagonally positioned conductor may have. Referring to FIG. 4a, showing an enlarged portion of FIG. 4, for example a leg 23C (carrying current of phase C) is bordered above and to the left by two legs 23B (carrying current of phase B) and is bordered below and to the right by two legs 23A (carrying current of phase A.) The skilled reader will appreciated that the corresponding magnetic fields generated by the conductor leg 23C will tend to be cancelled by corresponding magnetic fields generated by the conductor legs 23B and 23A of the other two phases. The result is lower inductance, which is particularly helpful in high frequency multiphase electrical systems, to reduce unwanted radiation and the inductance, which reduces the reactive voltage loss along the transmission line. This is particularly important for low voltage high current power supply systems where the loss can be an appreciable percentage of the available voltage.

Various interlacing patterns may be provided for the phases, however preferably to achieve maximum result, any conductor of a given phase has as its neighbours conductors of the two other phases (in a 3-phase system), and preferably the two other phases are provided in equal numbers around the given conductor of interest. The patterns will depend on the number of phases in the assembly 8. Referring to FIG. 5a, in another embodiment circular cross-section conductors lend themselves to an array or arrangement wherein each conductor of a given phase (say Phase A) may be bordered by three conductors from each of the other two phases (e.g. phases B and C). As well, from the further example provided in FIG. 5b, it is clear that many possible arrangements are possible. In FIGS. 5a and 5b, the linear arrays (i.e. rows and/or columns) which comprise the array may be non-aligned, or offset from one another. Also, the skilled reader will appreciate that while the described examples use single conductors, it will be appreciated that each “conductor” may in fact be a grouped plurality of conductors, for example, such as a conductor composed of many wires surrounded by an insulated perimeter, as shown in FIG. 5c. A variety of suitable conductor shapes and arrangements may be provided, and the skilled reader will appreciate that the shape and arrangement of the array may be affected by the number of phases to be balanced. The reader will also appreciate the selected pattern tends to affect the inductance-cancelling ability of the assembly.

While it is preferred that each phase conductor is surrounded by adjacent conductors of different phases, and the surrounding conductors of different phases are balanced among the remaining phases (i.e. equal numbers of conductors of the remaining phases surrounding the phase conductor of interest) to thereby yield optimum cancelling effect, other patterns may be suitable which include some adjacent conductors being of the same phase as the phase conductor of interest, and/or the phase conductor of interest being surrounded by unbalanced or unequal numbers of conductors from the remaining phases. In each application, one will tend to strive to arrange the conductors so as to achieve a balanced assembly overall, having an arrangement of conductors which is optimized to reduce inductance to a desired level.

The embodiment described above is intended to be exemplary only, and one skilled in the art will recognize that changes may be made to the embodiments described without departing from the invention disclosed. For example, any suitable number of phases may be used. The individual conductors need not be provided in layers or with integrally connected legs as shown above. In fact, the type, material, nature, shape and configuration of the conductors may be any suitable, and the conductors need not be the same as each other in each regard. Though generally array or grid-like arrangements of conductors are described, any suitable arrangement may be used. The array and/or pattern of conductors need not be regular or periodic. While arrangements of conductors described herein as an interlacing of individual conductors, it will be appreciated that conductors be provided in balanced groups using the approach described herein (e.g. groups of conductors carrying a given phase may be substituted for the single conductors represented in any of the examples described). Still other modifications will be apparent to those skilled in the art, in light of this disclosure, and therefore the invention is therefore intended to be limited solely by the scope of the appended claims.

We claim:

1. A current feeder assembly for feeding a 3-phase current signal from a source to a destination, said assembly comprising:
a plurality of insulated conductors configured to feed said 3-phase current signal, each conductor having a rectangular cross-section defined by four sides, the plurality of conductors provided in a rectangular array with said sides of adjacent conductors adjacent one another, the conductors arranged within the array such that said sides of a given conductor of the array feeding a given current phase are adjacent only conductors feeding the other two current phases.

2. The feeder assembly as in claim 1, wherein said plurality of conductors are provided in a pattern relative to the phases carried by the conductors, and wherein said pattern is repeated several times in said array.

3. The feeder assembly as in claim 1, wherein said conductors feeding said other two phases are provided in a balanced symmetrical pattern about said given conductor.

4. The feeder assembly as in claim 1, wherein said conductors feeding said other two phases are provided in numbers equal to one another.

5. The feeder assembly as in claim 1, wherein said array comprises a plurality of liner arrays, and wherein adjacent said linear arrays are partially offset relative to one another.

6. The feeder assembly as in claim 1, wherein said conductors comprise insulated printed circuits.

7. The feeder assembly as in claim 1, wherein said conductors each comprise a group of parallel conductor elements.

8. The feeder assembly as in claim 7, wherein parallel conductor elements are insulated from one another.

9. A feeder assembly for feeding a multiphase current signal from a source to a destination, said assembly comprising:
a plurality of insulated conductors, each conductor having a perimeter and being configured for carrying one phase of said multiphase current signal, each given conductor of the plurality being bordered about said perimeter substantially by conductors of the plurality feeding phases dissimilar to a phase fed by said given conductor.

10. The feeder assembly as in claim 9, wherein said conductors are provided within the plurality in a phase pattern which is repeated several times.

11. The feeder assembly as in claim 9, wherein said conductors feeding said dissimilar phases are provided in a balanced symmetrical pattern relative to one another about said given conductor.

12. The feeder assembly as in claim 9, wherein said conductors feeding said dissimilar phases are provided in numbers equal to one another.

13. The feeder assembly as in claim 9, wherein said conductors each comprise a group of parallel conductor elements.

14. The feeder assembly as in claim 13, wherein said parallel conductor elements are insulated from one another.

15. The feeder assembly as in claim 9, wherein said conductors comprise insulated printed circuits.

16. The feeder assembly as in claim 9, wherein said conductors comprise rectangular insulated conductors.

17. The feeder assembly as in claim 7, wherein said provided in an array having at least two rows.

18. The feeder assembly as in claim 7, wherein said rows are partially offset relative to one another.

19. A method of feeding a multiphase current signal comprising the steps of:
providing a plurality of conductors configured to feed the multiphase current signal; and
arranging the conductors relative to one another so that a magnetic field induced by current of a given phase passing through the conductors is substantially cancelled by magnetic fields induced by currents of dissimilar phases passing simultaneously through adjacent conductors.
